(19) United States
(12) Patent Application Publication
(10) Pub. No.: US 2017/0237394 A1
(43) Pub. Date: Aug. 17, 2017

(54) DEVICE TO REDUCE THE TEMPERATURE OF A SOLAR PHOTOVOLTAIC PANEL

(71) Applicant: Karl W. BÖER, Naples, FL (US)

(72) Inventor: Karl W. BÖER, Naples, FL (US)

(21) Appl. No.: 15/044,008

(22) Filed: Feb. 15, 2016

(51) Int. Cl. H02S 40/42

(52) U.S. Cl. CPC H02S 40/425

(57) ABSTRACT

A device is provided which reduces the temperature of a solar PV panel. The device includes an enclosure comprising a heat sink attachable to a bottom side of the solar PV panel to provide an air channel, and a tornado tube. The tornado pipe may be oriented vertically to the plane of the earth, and may act as a solar chimney, instigating a flow of air to enter the enclosure through an air inlet. This air flow may be drawn across the heat sink and exit back to the atmosphere through the tornado tube.

### CROSS-REFERENCE TO RELATED PATENT APPLICATION

This application claims priority from U.S. Provisional Patent Application No. 61/170,163, filed on Jun. 3, 2015, the disclosure of which is incorporated herein in its entirety by reference.

### TECHNICAL FIELD

This present invention relates to a thermal dissipation device for a solar panel, in particular to a device attachable to the bottom of a solar PV panel which directs air flow across a heat sink, wherein the air flow is triggered by a thermal pipe.

### BACKGROUND

In recent years, solar photovoltaic power generation as a clean energy source has attracted attention owing to increasing awareness of environmental issues such as global warming. Photovoltaic (PV) solar cells provide an excellent way of making solar electric energy cost competitive compared to conventional electric generation technologies such as fossil fuels or nuclear. Sunlight also produces heat that brings the PV solar cells to elevated temperatures, typically between 80 and 120° C. Because of this, the cell efficiency decreases proportionally with increased temperature typically by 0.3-0.45% per degree (in Sunpower Si Panels by 0.38%) to reduced electrical power output.

US 2014/0166073 A1 describes a non-power cooling type solar panel attachment, whereby a cooling fluid, such as water, cools the panel, by contacting the surface of the panel. Thereby, a closed box is arranged attaching the panel, where the cooling fluid circulates without in-or outlet of the cooling fluid.

### SUMMARY

The presently disclosed invention provides a device which reduces the temperature of a solar PV panel without moving parts. More specifically, the device includes an enclosure (a box) comprising of a heat sink that is a metal sheet with metal fins, which is attachable to the bottom side of a solar PV panel. The box includes an air inlet and an air outlet in fluid communication with a tornado pipe. The tornado pipe may be oriented vertically to the plane of the earth, and may act as a solar chimney, instigating a flow of air to be sucked from the air outlet of the box. This air flow may be drawn across the heat sink and being sucked into the tornado tube.

### BRIEF DESCRIPTION OF THE DRAWINGS

Aspects, features, benefits and advantages of the embodiments described herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale.

FIG. 1 illustrates a thermal dissipation device (the cooling device) according to an exemplary embodiment.

FIG. 2 illustrates various orientations of a heat transfer sheet according to an exemplary embodiment.

FIG. 3 illustrates a connection funnel and tornado pipe according to an exemplary embodiment.

FIG. 4 illustrates a connection funnel and tornado pipe according to an exemplary embodiment.

FIG. 5 illustrates a device with an opening in the middle of the device for wires of the E-20 PV Panel according to an exemplary embodiment.

FIG. 6 illustrates a detail of the connection between the solar panel, the frame of the solar panel and the enclosure (box) according to an exemplary embodiment.

FIGS. 6a and 6b illustrate a device with an opening in the middle of the device for wires of the E-20 PV Panel according to another example embodiment.

FIGS. 7 and 7a illustrate a device according to yet another example embodiment.

### DESCRIPTION OF EXEMPLARY EMBODIMENTS

In the following description, the present invention is set forth in the context of various alternative exemplary embodiments and implementations involving a thermal dissipation device (cooling device) for a solar PV panel. While the following description discloses numerous exemplary embodiments, the scope of the present patent application is not limited to the disclosed exemplary embodiments, but also encompasses combinations of the disclosed exemplary embodiments, as well as modifications to the disclosed example embodiments.

Various aspects of the thermal dissipation device may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the thermal dissipation device may be illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

Relative terms such as “lower” or “bottom” and “upper” or “top” may be used herein to describe one element's relationship to another element illustrated in the drawings. It will be understood that relative terms are intended to encompass different orientations of aspects of the thermal dissipation device in addition to the orientation depicted in the drawings. By way of example, if aspects of the thermal dissipation device in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

It must also be noted that as used herein and in the appended claims, the singular forms “a”, “an”, and “the” include the plural reference unless the context clearly dictates otherwise. Unless defined otherwise, all technical and scientific terms used herein have the same meanings as commonly understood by one of ordinary skill in the art.

The device according to an exemplary embodiment consists of a flat box that fits to the bottom of a solar PV panel and has a cover of a finned sheet for heat transfer. It has a slit opening at opposing ends for letting air in and out. At one end is a slim funnel that connects (under 45 degree) the airstream to a cylinder of small diameter, called tornado-pipe. The pipe may function as a solar chimney that is vertical to the earth's ground with circular, tornado-like air movement inside, and may create the necessary suction to make the air stream turbulent (in order to increase its velocity above a critical Reynold number) in order to maximize the heat transfer.

The device may reduce the operational temperature of a typical PV panel from about 100° C. at maximum sunlight exposure to less than 20° C. of the ambient temperature with an expected benefit of 0.3 to 0.45% gain in conversion efficiency for every degree temperature drop. Thus, a device according to an exemplary embodiment produced for an E-20 SUNPOWER panel with nominal 327 W electric output is expected to gain 0.38% per degree Celsius and may pay for itself in less than 2 years when deployed in a typical New York City (NYC) weather, or in excess of 15% return of investment (ROI). However in a preferred deployment in an arid climate, e.g., in Arizona or AbuDabi with 6 hours average full sunshine per day, the return is much higher with an expected ROI of 25%.

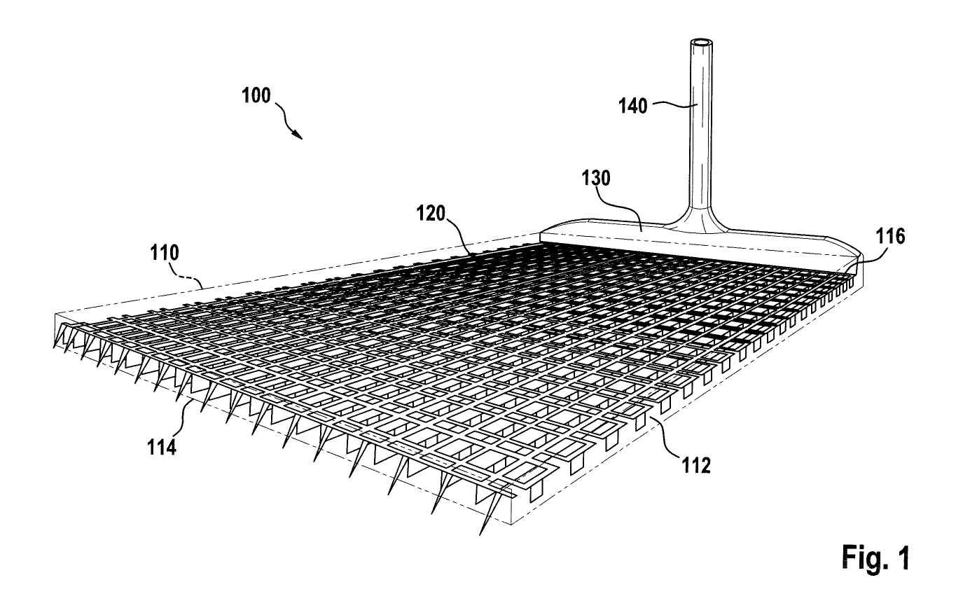

FIG. 1 illustrates a perspective view of a thermal dissipation device 100 according to an exemplary embodiment. The device 100 has an enclosure 110 which includes an enclosure base having two opposing upstanding sides 112, an inlet end 114, and an outlet end 116; at least one heat transfer sheet 120 sized to fit within the enclosure between the two opposing upstanding sides; a tornado pipe 140; and a connection funnel 130 having a first open end and a second open end. The first open end is sized and configured to connect to the outlet end of the enclosure 116 and the second open end is sized and configured to connect to the tornado pipe 140. Attachment of the two opposing upstanding sides of the enclosure to a bottom side of a solar PV panel may provide an air channel having a channel inlet adjacent to the inlet end of the enclosure 114 and a channel outlet 116 adjacent to the first open end of the connection funnel. The second open end of the connection funnel may be in fluid communication with the tornado pipe 140.

The enclosure 110 and/or the connection funnel 130 and/or the tornado pipe 140 may be composed of a metal sheat or a thermally stabile polymeric material. Exemplary polymeric materials include epoxy, polyimide, polyetherimide, cyanate ester, silicone, polyphenylenesulfide, polyaryletherketone, polyetheretherketone, polyarylsulfone, polyethersulfone, polytetrafluoroethylene, perfluoroalkoxy, nylon, polyvinyl chloride, or combinations thereof.

The tornado pipe 140 may be composed of a material, which is transparent for light having wave lengths in the area of the active spectrum of the absorber material of the panel. A proper material is for example plexiglass. This leads to a higher efficiency of adjacent panels, which would otherwise be shadowed by the tornado pipe 140 and thus would produce a reduced current compared with the unshadowed parts of the panel.

In certain exemplary embodiments, the tornado pipe 140 may be composed of a sheet metal, such as galvanized steel, or preferably a nonconducting polymetric material as described above. In this case, it may be preferably painted in black color to increase its internal temperature and to additionally assist the turbulent air flow.

The enclosure base may have a cross-sectional shape which is uniform in a longitudinal direction to enable extrusion molding. For example, the enclosure base and the two opposing upstanding sides 112 of the enclosure 110 may have a thickness of about 1 to 8 mm that is required for stability and to minimize cost.

The enclosure 110 has a height in the range from 6 to 7 cm (preferably 6.35 cm), with indentation in the range from 1 to 2 cm (preferably 1.27 cm) at the side to contain the panel and finned heat transfer sheet 120, and a thickness of the bottom in a range from 0.75 cm to 1.5 cm (preferably 0.9525 cm). The fins 220 inside the enclosure 110 have a length of 1 to 2 cm (preferably 1.625 cm), fitting to closely touch the bottom of the enclosure for a tight fit. In other words, the length of the fins 220 is preferably in the range of the inner height of the enclosure 110, so that the fins 220 are in contact with and supported by the inner surface of the enclosure 110. In order to secure the fins 220 during transportation from slight sideways motion the fins 220 may rest in ⅛″ deep v-shaped riles along the bottom of the box. According to another example embodiment some space may be provided between then fins 220 and the bottom of the enclosure 110, an arrangement that has slight advantages since it decouples the heat from the fins 220 and the enclosure 110.

The enclosure 110 may be attached to the bottom side of the solar photovoltaic (PV) panel via an adhesive with a 30 year life expectancy under daily temperature cycling of 60° C. alternatively or additionally it may include mechanical clamps. The bottom side of the photovoltaic panel according to an exemplary embodiment of the invention is the side opposite to the active side of the panel, i.e., it is the side, which is shadowed in a motion mode of the panel.

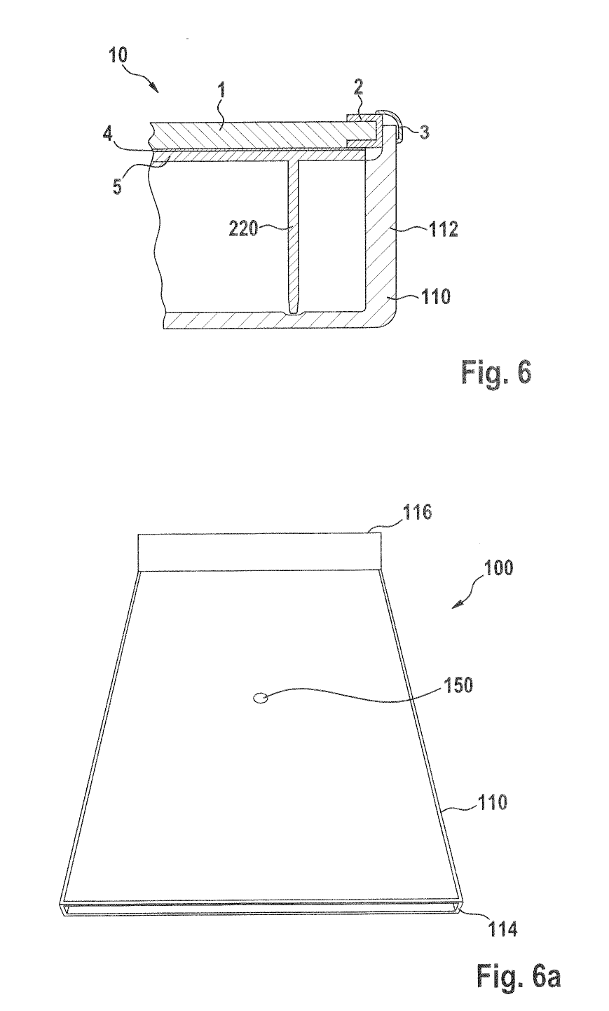

A connection between the solar PV, the frame 2 of the solar PV and the enclosure 110 according to an exemplary embodiment is shown in FIG. 6. More specifically, FIG. 6 shows a combination of fixing tools. First, the panel 1 is fixed to the device 100 by clamps which are snapped through between the frame 3 of the panel and one of the opposing upstanding sites 112, respectively, and second by an adhesive 4. FIGS. 6a, and 6b show the top of the panels with the solar cells on top pointing toward the sun. In the bottom of the enclosure (box) 110 is a hole through which the wires are fed from the solar panels to the underlying roof.

Clamps 3 may optionally be arranged to fix the funnel 130 and/or the tornado pipe 140 to the panel 1, preferably to its frame 2, and/or to the enclosure 110 via an elastomer string.

In certain exemplary embodiments, the two opposing upstanding sides 112 may each include a region of increased thickness at an edge opposite of the enclosure base, thus providing a greater surface area for the adhesive to bond the enclosure to the bottom of the solar PV panel.

In certain other exemplary embodiments, the enclosure 110 may be attached to the bottom side of the solar PV panel via a plurality of clamps 3.

Once the enclosure 110 is attached to a bottom side of the solar PV panel 1, an air channel is formed having an air inlet 114. The height of the air channel is slightly larger than the height of the fins extending into the channel, typically by 10% (from 5-20%). For example, the height of the air channel itself may be 5 to 15 cm, with the heights of the fins slightly less. Furthermore, the height of the air channel inlet 114 formed when the two opposing upstanding sides 112 of the enclosure 120 are attached to the bottom side of the solar PV panel may be smaller than the height of the air channel For example, the air channel inlet 114 may be only about 40 to 75% of the height of the channel. The height of the air outlet may be a little larger, typically 60 to 90% of the height of the channel in order to restrict little of the air flow, but to provide enough material to glue the funnel to the outlet 116.

In certain exemplary embodiments, the enclosure base may have a dimension of about 100 cm on opposing short sides and about 150 cm on opposing long sides or of appropriate six times of the dimension of the solar panels to which they are attached. Each of the two opposing upstanding sides 112 of the enclosure base may be attached along each of the opposing short sides of the enclosure base. The width of the air channel inlet 114 formed when the two opposing upstanding sides of the enclosure are attached to the bottom side of the solar PV panel may be the same as the width of the enclosure base, or may be smaller than the width of the air channel. For example, the enclosure base may be 100 cm wide and the air channel inlet 114 may be only 95 cm wide.

The device may include at least one heat transfer sheet 120. Each heat transfer sheet 120 has a front edge, a plurality of spaced fins 220, and, optionally, a plurality of spaced openings 210. There are two preferred ways to build the fins 220. Thereby, each of the plurality of spaced fins 220 includes a section of material of the heat transfer sheet 120 (a) being removed to form each of the plurality of spaced openings 210 or (b) being welded to form a profile of elevations and grow downs. The second alternative (b) has the advantage of increasing the heat transfer surface by making the finned surface stick to the panel surface without peeling loose from the outer edges.

In both alternatives, the heat transfer sheet 120 is preferably adhered with a heat transfer compound, preferably a silicon or non-silicon oil, to the enclosure. This has the advantage of taking care of the differential thermal expansion. For example the compound MG Chemicals Code SDS 860 or 8610, or the CG Electronics Type Z9 Heat Sink Compound could be used as heat transfer adhesive 3. The compound may be put onto the metal sheet between the fins 220 in beets and pressed flat when turned around to the Solar PV Panel for adhesion. This simplifies installation and avoids cumbersome painting of the compound to the finned metal surface.

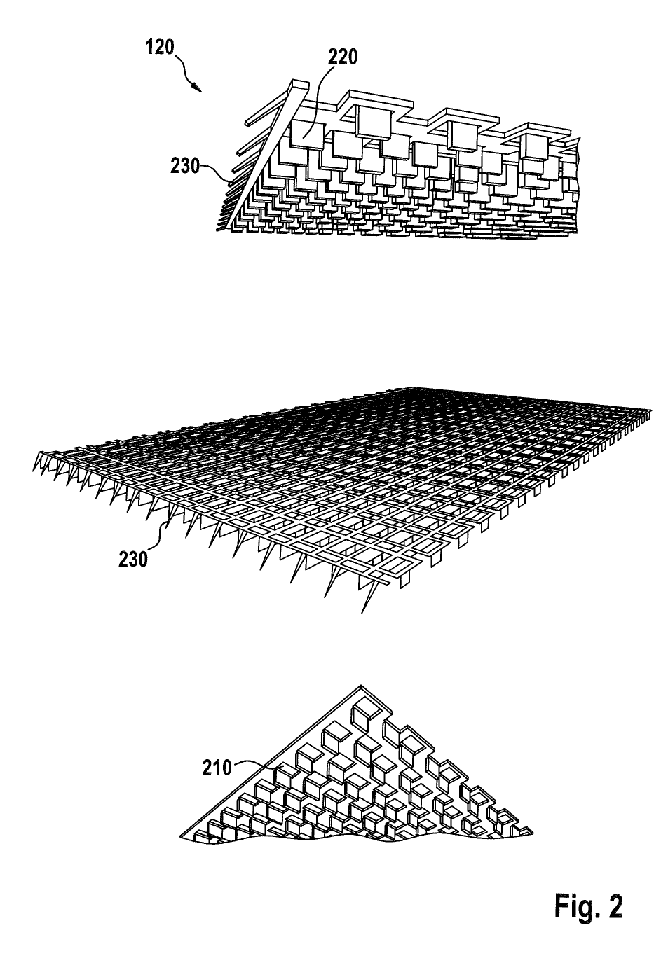

As shown in FIG. 2, each heat transfer sheet 120 may have a front edge, a plurality of spaced needles 210, and a plurality of spaced fins 220. Each of the plurality of spaced fins 220 may include a small section of material of the heat transfer sheet removed and bend upward to form each of the plurality of spaced openings and fins. Furthermore, each of the plurality of spaced fins 220 may be bent 90° relative to a longitudinal plane of the heat transfer sheet.

In certain exemplary embodiments, the plurality of spaced openings 210 may be formed in at least two rows of openings. The at least two rows of openings may be offset so that a front of each of the plurality of spaced fins 220 is exposed to an air flow in the air channel. For example, the offset may be about 1 cm while the opening is 2×2 cm². Furthermore, each of the plurality of spaced openings 210 of the heat transfer sheet 120 may have a dimension of about 2 cm². In a preferred embodiment there will be at least 60 rows in series, each one offset from the next one by half the width of the holes.

In certain exemplary embodiments, the heat transfer sheet 120 may have a thickness of about 1 to 3 mm, typically of 1.5 mm. The heat transfer sheet 120 may be composed of a thermally conductive material, such as highly conductive (pure) copper or highly conductive (pure) aluminum, or of similar highly heat conductive and inexpensive materials.

Individual heat transfer sheets 120 may be separated along a longitudinal plane within the enclosure 110. For example, adjacent heat transfer sheets may be separated along a longitudinal plane within the enclosure by a distance of about 1 mm to account for differential expansion coefficients of the sheet and the PV panel.

At least one heat transfer sheet 120 may include a turbulence initiator strip 230 on the front edge. The front edge may be positioned nearest to the channel inlet 114. An exemplary turbulence initiator strip 230 includes a row of needles with projections having a triangular cross-section to initiate turbulent airflow. The projections may have sharp edges and may be placed with their broad base facing the air flow.

In certain exemplary embodiments, the device may include four separate heat transfer sheets for the length of each solar panel to minimize the negative effect of differential thermal expansion on the life-expectancy. A thin spacer may be included between each sheet to maintain a safe distance (about 1 mm) between each sheet that will self-eliminate after a few initial operational cycles.

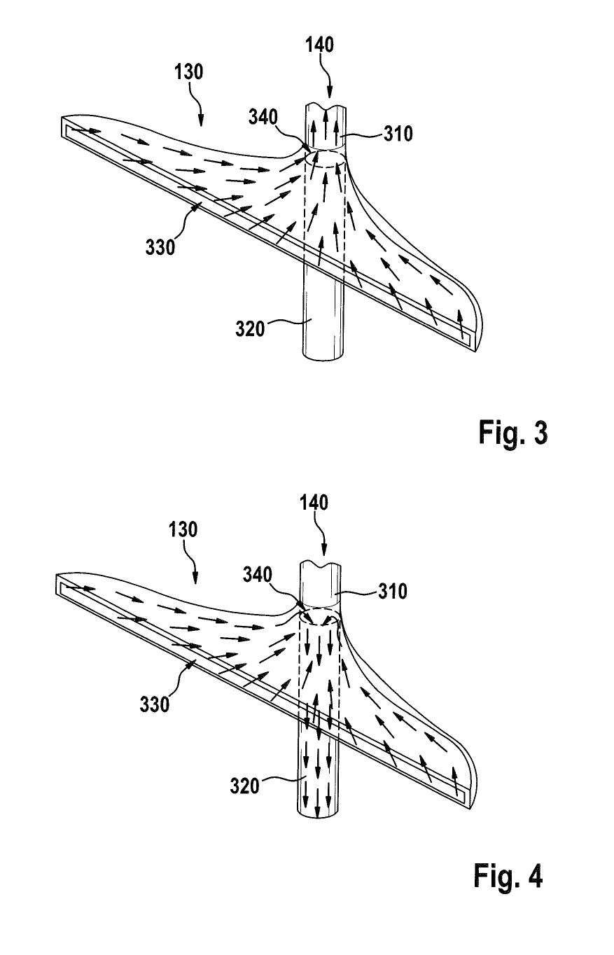

As shown in FIGS. 3 and 4, in certain exemplary embodiments, the second open end of the connection funnel 130 may be attached to the tornado funnel 140 at a midpoint of the tornado funnel 310. In such instances, the device may include a valve 340 which may be used to direct the air flow 330 in an upward direction, as shown in FIG. 3, or in a downward direction, as shown in FIG. 4. For example, in a cold climate, the valve 340 may be used to direct the air flow in a downward direction, such as toward a portion of a building, and may be used to provide a source of heated air to the building. In such embodiments, a pump may be used to pull the air through the air inlet 330 of the funnel to exit through a lower portion of the pipe 320.

The valve 340 may be controlled manually, or may be activated by an external sensor, such as an external temperature sensor. As such, when an external temperature drops below a certain set point, the valve may be switched to direct the air flow in a downward direction 320. Further, several panels may be connected closely to each other in parallel and the air flow downward may be collected in a horizontal pipe and pumped downward by only one pump. Further, the heated air may be pumped down into hollow cinderblocks that act as room-dividers and also act as some heat storage devices to maintain heating beyond the time the sun shines.

In certain exemplary embodiments, the second open end 340 of the connection funnel 130 may include an upstanding tube. The tornado pipe 140 includes a top pipe portion 310 attachable to an upper portion of the upstanding pipe and a bottom portion 320 attachable to a lower portion of the upstanding tube. In all exemplary embodiments, however, at least one portion of the tornado pipe 140 is in fluid communication with the air channel formed by the enclosure 110 via the connection funnel 130.

During normal operation, the valve 340 may direct the air to exit from the top of the tornado pipe 140. The tornado pipe acts as a solar chimney, and may produce the suction needed to pull air through the device. As such, and with reference to FIG. 1, cooler external air may be pulled into the air inlet channel 114, across the heat transfer sheets 120, through the connection funnel 130, and may exit the tornado pipe 140 out into the environment. In certain exemplary embodiments, the device may include a tornado pipe attachment releasably attachable to a top end of the tornado pipe. The tornado pipe attachment may direct an air flow out of the tornado pipe in a direction substantially against an external air flow to minimize initiation of a meteorological tornado.

The tornado pipe 140 may connect to the connection funnel 130 at an angle that places the tornado pipe 140 in a vertical orientation when in normal deployment. For example, a standard installation of a solar PV panel places the panel normal to the sun, i.e. typically inclined under 30 to 45° depending on the place of deployment (latitude) and technology (silicon, thin film a.s.o.)) to the earth's surface. Thus, the tornado pipe 140 may be connected to the connection funnel at an angle of 45(±15)°. The angle of the connection funnel may be adjustable to maintain the tornado pipe 140 in a vertical orientation for different panel deployments between 0 and 180 degree to the earth's surface.

The inside of the connection funnel 130 may be smooth and may avoid sharp corners to minimize resistance to the air flow. Further, toward the entry of the tornado pipe 140, two small fins may be included inside the connection funnel 130 to direct the air from opposite sides into circular motion. It is proposed to orient this motion to the left or right depending on the deployment in the northern or southern hemisphere, to minimize inducing external tornados

The glue to connect the finned sheet to the solar panel is preferably of flexible graphite filled cement with high ductility and heat transfer and 30 year life expectancy under daily temperature cycling of 60° C. Alternatively, a commercially available thin heat transfer sheet may be provided that can be used after peeling off the two protecting cover sheets to stick the finned sheet 120 to the bottom of the solar PV Panel.

A Tornado Spoiler may be provided on top of the tornado pipe to prevent an accidental initiation of a meteorological tornado, a weather-vane type of spoiler that directs the out-coming turbulent air under 125° against the outside wind direction.

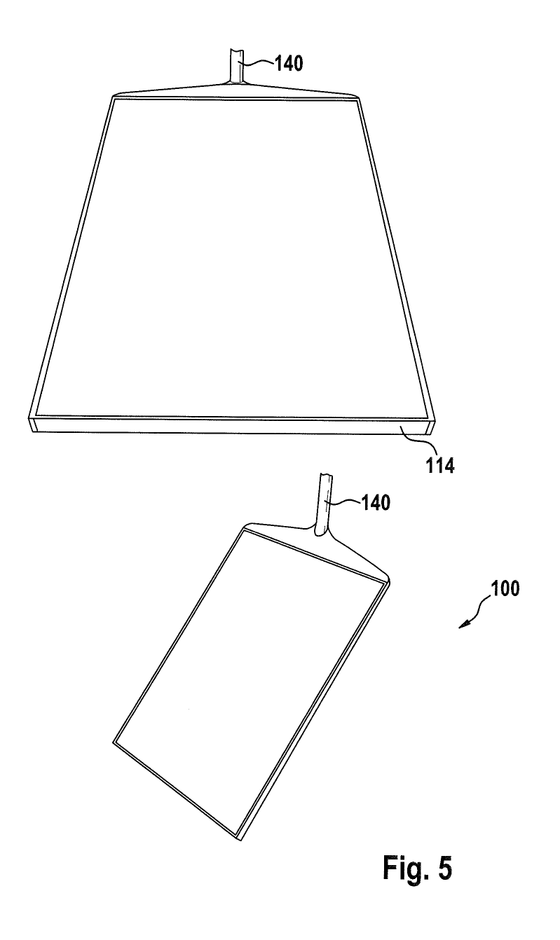

FIG. 5 and FIGS. 6a and 6b illustrate further exemplary embodiments of the invention. In order to make the tornado pipe more effective it is (a) most important to orient it vertically to minimize bouncing of the spiral flow for and back on the walls and (b) to cover the interior surface with a surface friction reducing cover like the one used for water drop repellents on wind shields or in dishwashers for increasing the flow. FIGS. 6a and 6b show opening 150 in the middle of the device for wires of the E-20 PV Panel;

FIG. 6 shows a part of the cross section of an inventive solar panel attachment that includes a photovoltaic panel which is mounted on an inventive dissipation device. As shown in FIG. 6, the fins 220 are made from the plate 5, which has a thickness of 1.5 to 4 mm, preferably of 2 mm. Preferably, the fins 220 are in contact with the bottom of the enclosure 110 to stabilize the fins 220. In accordance with an exemplary embodiment, there are recesses build on the bottom of the enclosure 110 for receiving the fins 220. Preferably, the recesses are trapezoidal, 2.5 cm apart and/or 2 mm deep.

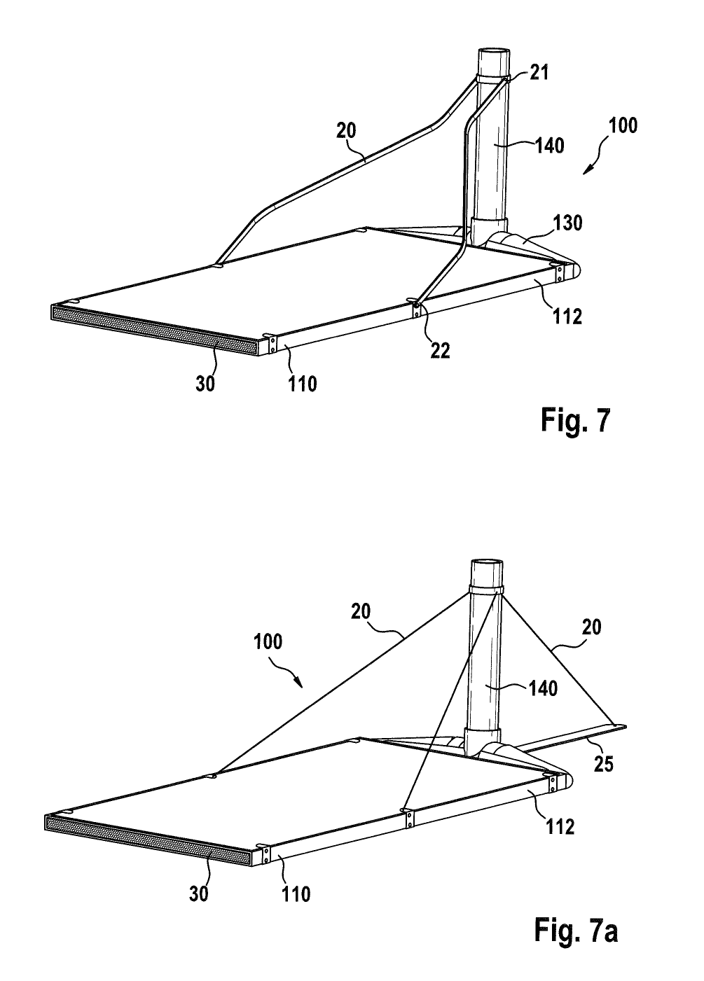

FIG. 7 shows a further exemplary embodiment of the invention. In order to stabilize the tornado pipe 140, an additional stabilization means should be mounted, which connects the tornado pipe 140 with the panel frame 2 and/or the upstanding sides 112 of the enclosure 110 in a triangular way. In a preferred embodiment it is realized, by a stabilization means 20 having a first end 21 and a second end 22, e.g. a rope, connecting the tornado pipe 140 (preferably mounted in a middle area of the tornado pipe 140) on its first end 21 and the panel 1 or the upstanding sides 112 of the enclosure 110 on its second end 22. The embodiment shown in FIG. 7 also shows a fluid permeable barrier 30 (e.g. a mesh) arranged in front of the inlet end 114. The barrier 30 covers the openings and thus prevents the penetration of animals (such as mice and insects) and/or dirt into the enclosure. This barrier 30 could be mounted to all the embodiments of the invention.

A further possibility to stabilize the tornado pipe 140 is given by the exemplary embodiment shown in FIG. 7a. In this embodiment, the device further includes a stick 25 which should be pulled from the end of the enclosure 110 which is adjacent to the tornado pipe 140. The stick 25 is than connected with the tornado pipe 140 through the stabilization means 20.

While exemplary embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

In summary, in one form a thermal dissipation device is provided as substantially described in the specification and accompanying drawings that includes an enclosure comprising an enclosure base having two opposing upstanding sides, an inlet end, and an outlet end; when two panels are in series arranged, then the entrance and exit slits are eliminated and the panels are budded closely together so as to minimize air resistance, at least one heat transfer sheet sized to fit within the enclosure between the two opposing upstanding sides, a tornado pipe, and a connection funnel having a first open end and a second open end, wherein the first open end is sized and configured to connect to the outlet end of the enclosure and the second open end is sized and configured to connect to the tornado pipe. Attachment of the two opposing upstanding sides of the enclosure to a bottom side of a solar PV panel provides an air channel having a channel inlet adjacent the inlet end of the enclosure, and the tornado pipe is in fluid communication with the channel inlet.

Preferably each heat transfer sheets has a front edge, a plurality of spaced openings, and a plurality of spaced fins. Additionally, each of the plurality of spaced fins includes a section of material of the heat transfer sheet removed to form each of the plurality of spaced openings. Moreover it is preferred, that each of the plurality of spaced fins is bent upward, preferably under 90° relative to a longitudinal plane of the heat transfer sheet. Further, the plurality of spaced openings are formed in at least two rows of openings.

In another form, the thermal dissipation device has at least two rows of openings that are offset so that a front of each of the plurality of spaced fins is exposed to an air flow in the air channel. It is preferred, that the at least two rows of openings are offset by about half the size of the hole or about 1 cm. Additionally, each of the plurality of spaced openings of the heat transfer sheet have a dimension of about 2 cm square or any other rectangular form, e.g. in a preferred for of 5×12 cm or triangular form. Moreover, it is advantageous, that the heat transfer sheet has a thickness of about 1 to 3 mm, preferably of 2 mm. Further, the heat transfer sheet includes a thermally conductive material.

In yet another form, the thermally conductive material of the thermal dissipation device includes copper, aluminum, or other highly heat conductive materials. The enclosure includes a thermally stabile polymeric material or a metal sheet and the polymeric material includes an epoxy, polyimide, polyetherimide, cyanate ester, silicone, polyphenylenesulfide, polyaryletherketone, polyetheretherketone, polyarylsulfone, polyethersulfone, polytetrafluoroethylene, perfluoroalkoxy, nylon, polyvinyl chloride, or combinations thereof. Or the metal sheet is galvanized iron, or aluminum or other metal that is inexpensive, weather resistant and mechanically stable. In another form, the enclosure is attached the bottom side of the solar PV panel via an adhesive. The adhesive includes a graphite filled or Z7 compound filled cement or a heat transfer plastic sticking sheet. The thermal dissipation device further includes a tornado pipe attachment releasable attachable to a top end of the tornado pipe. The tornado pipe attachment directs an air flow out of the tornado pipe in a direction substantially against the preferential rotation of an external tornado forming air flow. The tornado pipe has a diameter of 3 cm to 8 cm and a length of 0.5 meters to 2.5 meters. The tornado pipe has a diameter of about 5 cm and a length of about 1.5 meters.

The connection funnel includes a thermally stabile polymeric material. The polymeric material includes an epoxy, polyimide, polyetherimide, cyanate ester, silicone, polyphenylenesulfide, polyaryletherketone, polyetheretherketone, polyarylsulfone, polyethersulfone, polytetrafluoroethylene, perfluoroalkoxy, nylon, polyvinyl chloride, or combinations thereof. The enclosure base has a cross-sectional shape which is uniform in a longitudinal direction to enable extrusion molding. The enclosure base and the two opposing upstanding sides are sized and configured to attach to the bottom side of the solar PV panel adjacent an edge of the solar PV panel.

The enclosure is attached the bottom side of the solar PV panel via an adhesive. The two opposing upstanding sides each include a region of increased thickness at an edge opposite of the enclosure base. The enclosure is attached the bottom side of the solar PV panel via an adhesive applied to the region of increased thickness.

In yet another form, the enclosure is attached to the bottom side of the solar PV panel via a plurality of clamps. The enclosure base and the two opposing upstanding sides have a thickness of about 8 mm.

A height of the air channel formed when the two opposing upstanding sides of the enclosure are attached to the bottom side of the solar PV panel is about 5 cm. A height of the channel inlet formed when the two opposing upstanding sides of the enclosure are attached to the bottom side of the solar PV panel is smaller than the height of the air channel.

In another form, a height of the channel inlet formed when the two opposing upstanding sides of the enclosure are attached to the bottom side of the solar PV panel is 3 cm. The enclosure base has a dimension of about 100 cm on opposing short sides and about 150 cm on opposing long sides. Each of the two opposing upstanding sides of the enclosure base are attached along each of the opposing short sides of the enclosure base.

A width of the channel inlet formed when the two opposing upstanding sides of the enclosure are attached to the bottom side of the solar PV panel is smaller than the width of the air channel. In another form, a width of the channel inlet formed when the two opposing upstanding sides of the enclosure are attached to the bottom side of the solar PV panel is 95 cm. The tornado pipe connects to the connection funnel at an angle of about 45°.

The tornado pipe is vertical under normal deployment on a roof top or any other conventional deployment structures. The tornado pipe connects to the connection funnel at an adjustable angle so that the tornado pipe is vertical under any normal deployment on a roof top.

In yet another form, a thermal dissipation device, further including two blades attachable at the second open end of the connection funnel, wherein the two blades direct an air flow through the air channel to exit the tornado pipe in a circular motion.

In another form, the circular motion is left rotating or right rotating depending on the hemisphere of deployment. In yet another form, more than one tornado pipe is connected in parallel through a wider funnel to increase the suction for increased air flow along the heat transfer sheet and its fins. When more than one Tornado pipe is used, the height of each tornado pipe may be substantially reduces compared to a single one.

In yet another form, the parallel sets of Tornado pipes are hidden behind a shield to make a more esthetic appearance. The thermal dissipation device may include four heat transfer sheets. Adjacent heat transfer sheets are separated along a longitudinal plane within the enclosure.

In another form, the adjacent heat transfer sheets are separated along a longitudinal plane within the enclosure by a distance of about 1 mm.

The heat dissipation device has an expected performance benefit of about 0.38% gain in a conversion efficiency for every degree temperature drop. At least one heat transfer sheet includes a turbulence initiator strip on the front edge. The front edge is positioned nearest the channel inlet. The turbulence initiator strip includes projections having a triangular cross-section, preferably with sharp edges toward the incoming air stream.

In yet another form, a non-power cooling type solar panel attachment is provided that includes a solar PV panel provided with solar cells for converting sunlight into electric energy, the panel having a top side for collecting the sunlight and a bottom side directly opposite the top side; and a thermal dissipation device configured for attachment to the bottom side of the solar PV panel. The thermal dissipation device includes an enclosure having an enclosure base having two opposing upstanding sides, an inlet end, and an outlet end, at least one heat transfer sheet sized to fit within the enclosure between the two opposing upstanding sides, a tornado pipe; and a connection funnel having a first open end and a second open end. The first open end is sized and configured to connect to the outlet end of the enclosure and the second open end is sized and configured to connect to the tornado pipe. Attachment of the two opposing upstanding sides of the enclosure to a bottom side of a solar PV panel provides an air channel having a channel inlet adjacent the inlet end of the enclosure, and the tornado pipe is in fluid communication with the channel inlet.

In another form, each heat transfer sheet of the thermal dissipation device has a front edge, a plurality of spaced openings, and a plurality of spaced fins. The non-power cooling type solar panel attachment further includes a tornado pipe attachment releasable attachable to a top end of the tornado pipe. The tornado pipe attachment directs an air flow out of the tornado pipe in a direction with a component substantially against the flow of a potential or developing tornado.

1. A thermal dissipation device for cooling a solar photovoltaic panel, the thermal dissipation device comprising:
an enclosure including an enclosure base having two opposing upstanding sides, an inlet end, and an outlet end;
at least one heat transfer sheet sized to fit within the enclosure between the two opposing upstanding sides;
a tornado pipe;
a connection funnel having a first open end and a second open end, wherein the first open end is configured to connect to the outlet end of the enclosure and the second open end is configured to connect to said tornado pipe;
an attachment arrangement configured to attach the two opposing upstanding sides of the enclosure to a bottom side of the solar photovoltaic panel so as to cause the enclosure and the solar photovoltaic panel to conjointly define an air channel having a channel inlet adjacent to the inlet end of the enclosure when the solar photovoltaic panel is mounted on the thermal dissipation device;
said tornado pipe being in fluid communication with said channel inlet; and,
said tornado pipe being configured to operate as a solar chimney by arranging said tornado pipe substantially vertical to an earth surface normal so as to cause an air flow through said air channel across said at least one heat transfer sheet and through said tornado pipe.

2. The thermal dissipation device according to claim 1, wherein each of the at least one heat transfer sheet has a front edge, a plurality of spaced fins, and a plurality of spaced openings.

3. The heat dissipation device according to claim 2, wherein each of the plurality of spaced fins has a section of material of the at least one heat transfer sheet that is (a) removed to form the plurality of spaced openings or (b) being welded to form a profile of elevations and grow downs.

4. The heat dissipation device according to claim 3, wherein each of the plurality of spaced fins is bent upward at an angle of 90° relative to a longitudinal plane of the at least one heat transfer sheet as the section of material of the at least one heat transfer sheet is removed to from the plurality of spaced openings.

5. The thermal dissipation device according to claim 2, wherein the plurality of spaced openings is formed in at least two rows of openings; and,
wherein the at least two rows of openings are offset so that a front of each of the plurality of spaced fins is exposed to an air flow in the air channel.

6. The thermal dissipation device according to claim 1, wherein:
the at least one heat transfer sheet is made of a thermally conductive material; and,
the thermally conductive material is at least one of copper, aluminum and another highly heat conductive material.

7. The thermal dissipation device according to claim 1, wherein the at least one heat transfer sheet is connected to the enclosure by glue and/or an adhesive heat transfer compound.

8. The thermal dissipation device according to claim 1, wherein:
the enclosure and/or the connection funnel is made of a thermally stabile polymeric material; and,
the thermally stabile polymeric material is at least one of epoxy, polyimide, polyetherimide, cyanate ester, silicone, polyphenylenesulfide, polyaryletherketone, polyetheretherketone, polyarylsulfone, polyethersulfone, polytetrafluoroethylene, perfluoroalkoxy, nylon, polyvinyl chloride, combinations thereof, a metal sheet, galvanized iron, and aluminum.

9. The thermal dissipation device according to claim 1, further comprising:
a tornado pipe attachment releasably attached to a top end of the tornado pipe,
wherein the tornado pipe attachment directs the air flow out of the tornado pipe in a direction substantially opposite to a rotation of an external air flow forming a natural tornado.

10. The thermal dissipation device according to claim 1, wherein the tornado pipe connects to the connection funnel at an angle of 45 (±15)°.

11. The heat dissipation device according to claim 1, further comprising:
an adjustable connection means connecting the tornado pipe to the connection funnel at an adjustable angle.

12. The thermal dissipation device according to claim 1, further comprising:
at least two stationary blades arranged at the second open end of said connection funnel to cause a circular motion of said air flow in said tornado pipe so as to create a suction that causes said air flow across said at least one heat transfer sheet to be turbulent.

13. (canceled)

14. The thermal dissipation device according to claim 1, further comprising:
at least two heat transfer sheets, wherein heat transfer sheets of the at least two heat transfer sheets that are adjacent to one another are separated along a longitudinal plane within the enclosure by a distance of about 1 mm.

15. The thermal dissipation device according to claim 2, wherein:
the at least one heat transfer sheet includes a turbulence initiator strip arranged on the front edge;
the front edge is positioned nearest to the channel inlet; and,
the turbulence initiator strip includes projections having a triangular cross-section with sharp edges directed towards an incoming air stream to initiate a turbulent airflow across said at least one heat transfer sheet.

16. A non-power cooling type solar panel assembly comprising:
a thermal dissipation device according to claim 1;
said solar photovoltaic panel having an active side and a bottom side opposite to the active side; and,
said thermal dissipation device being attached to the bottom side of said solar photovoltaic panel.

17. The non-power cooling type solar panel assembly according to claim 16, wherein:
said solar photovoltaic panel has two opposite upstanding sides;
said enclosure base of the thermal dissipation device and the two opposite upstanding sides of the solar photovoltaic panel are configured to attach to the bottom side of said solar photovoltaic panel adjacent to an edge of said solar photovoltaic panel.

18. The non-power cooling type solar panel assembly according to claim 16, wherein:
the enclosure of the thermal dissipation device is attached to the solar photovoltaic panel via a plurality of clamps or an adhesive; and,
the adhesive comprising a graphite filled cement or a heat transfer plastic sticking sheet.

19. The non-power cooling type solar panel assembly according to claim 16, wherein a height of the channel inlet formed when the two opposing upstanding sides of the enclosure are attached to the bottom side of the solar photovoltaic panel is smaller than a height of the air channel and/or a width of the air channel.

20. The non-power cooling type solar panel assembly according to claim 16, further comprising:
a plurality of clamps arranged to clamp said connection funnel and said tornado pipe to said solar photovoltaic panel and/or to said enclosure.

21. The non-power cooling type solar panel arrangement according to claim 16, wherein:
the thermal dissipation device further includes at least one stabilization means; and,
the at least one stabilization means connects the tornado pipe with the solar photovoltaic panel and/or with the opposing upstanding sides of the enclosure.

22. A thermal dissipation device for cooling a solar photovoltaic panel, the device comprising:
an enclosure including an enclosure base having two opposing upstanding sides, an inlet end, and an outlet end;
at least one heat transfer sheet sized to fit within the enclosure between the two opposing upstanding sides;
at least two tornado pipes arranged parallel to one another;
a connection funnel having a first open end and a second open end, wherein the first open end is configured to connect to the outlet end of the enclosure and the second open end is configured to connect to the at least two tornado pipes;
an attachment arrangement configured to attach the two opposing upstanding sides of the enclosure to a bottom side of the solar photovoltaic panel so as to cause the enclosure and the solar photovoltaic panel to conjointly define an air channel having a channel inlet adjacent to the inlet end of the enclosure when the solar photovoltaic panel is mounted on the device;
said at least two tornado pipes being in fluid communication with the channel inlet; and,
said at least two tornado pipes being configured to operate as solar chimneys by arranging said at least two tornado pipes substantially vertical to an earth surface normal so as to cause an air flow through said air channel across said at least one heat transfer sheet and through said at least two tornado pipes.

23. The thermal dissipation device of claim 22, further comprising:
a plurality of stationary blades arranged at the second open end of said connection funnel to cause circular motions of respective portions of said air flow in said at least two tornado pipes so as to create a suction that causes said air flow across said at least one heat transfer sheet to be turbulent.

24. A method for cooling a solar photovoltaic panel, the method comprising:
providing an enclosure including an enclosure base having two opposing upstanding sides, an inlet end, and an outlet end;
arranging at least one heat transfer sheet within the enclosure between the two opposing upstanding sides;
arranging at least two tornado pipes parallel to one another;
providing a connection funnel having a first open end and a second open end;
connecting the first open end to the outlet end of the enclosure;
connecting the second open end to the at least two tornado pipes;
mounting a bottom side of the solar photovoltaic panel on the two opposing upstanding sides of the enclosure so as to cause the enclosure and the solar photovoltaic panel to conjointly define an air channel having a channel inlet adjacent to the inlet end of the enclosure when the solar photovoltaic panel is mounted on the device, wherein said at least two tornado pipes are in fluid communication with said channel inlet; and,
causing an air flow through said air channel across said at least one heat transfer sheet and through said at least two tornado pipes by arranging said at least two tornado pipes substantially vertical to an earth surface normal and thereby causing said at least two tornado pipes to operate as solar chimneys.

25. The method of claim 24, further comprising:
arranging a plurality of stationary blades at the second open end of said connection funnel to cause circular motions of respective portions of said air flow in said at least two tornado pipes so as to create a suction that causes said air flow across said at least one heat transfer sheet to be turbulent.
